(19) United States
(12) Patent Application Publication
(10) Pub. No.: US 2019/0066382 A1
(43) Pub. Date: Feb. 28, 2019

(54) DRIVING SUPPORT DEVICE, DRIVING SUPPORT METHOD, INFORMATION PROVIDING DEVICE AND INFORMATION PROVIDING METHOD

(71) Applicant: DENSO TEN Limited, Kobe-shi (JP)

(72) Inventors: Tatsuki KUBO, Kobe-shi (JP); Tamaki TAKEUCHI, Kobe-shi (JP)

(73) Assignee: DENSO TEN Limited, Kobe-shi (JP)

(21) Appl. No.: 16/040,836

(22) Filed: Jul. 20, 2018

(30) Foreign Application Priority Data
Aug. 31, 2017 (JP) 2017-167380
Aug. 31, 2017 (JP) 2017-167386

(51) Int. Cl. G06T 19/00; G01C 21/36

(52) U.S. Cl. CPC G06T 19/006; G05D 1/0212; G01C 21/3667

(57) ABSTRACT

A driving support device includes a generation portion which generates a picture of a first virtual vehicle and a superimposition portion which superimposes the picture the first virtual vehicle on a surrounding image showing a vicinity of a present vehicle. The picture of the first virtual vehicle is moved, ahead of a current position of the present vehicle, along a guide route up to a destination of the present vehicle in the surrounding image.

This nonprovisional application claims priority under 35 U.S.C. § 119(a) on Patent Application No. 2017-167380 filed in Japan on Aug. 31, 2017 and Patent Application No. 2017-167386 filed in Japan on Aug. 31, 2017, the entire contents of which are hereby incorporated by reference.

### BACKGROUND OF THE INVENTION

### Field of the Invention

The present invention relates to a driving support technology and a technology for providing information to an occupant in a vehicle.

### Description of the Related Art

A navigation device mounted in a vehicle calculates and shows a travel route from the current position of the vehicle to a destination. Specifically, the navigation device makes a display device display an image obtained by superimposing a guide route on a map image in the vicinity of the current position of the vehicle, and makes a speaker output a voice guidance on the route guide such as a right turn instruction or a left turn instruction so as to show the travel route from the current position of the vehicle to the destination. There is also a navigation device which has the function of making a display device display an image obtained by superimposing an arrow or the like indicating a right turn instruction or a left turn instruction when a right turn or a left turn is necessary.

However, even with the voice guidance or the arrow display described above, it may be difficult to understand how the vehicle is driven, and thus it may be difficult for a driver to perform appropriate driving. For example, at an intersection where a plurality of roads, such as a five-forked road, which serve as a right turn candidate and a left turn candidate are present, even when a right turn instruction or a left turn instruction is provided by the voice guidance or the arrow display described above, it is likely that the driver cannot intuitively grasp an appropriate travel path.

In a vehicle image display system disclosed in Japanese Unexamined Patent Application Publication No. 2016-182891, when an automatic driving system makes the present vehicle take an unexpected travel action different from a planned travel action, an image which visually indicates the unexpected travel action by a virtual vehicle is previously displayed as a prediction. Since in the vehicle image display system disclosed in Japanese Unexamined Patent Application Publication No. 2016-182891, a case where the automatic driving system makes the present vehicle take an unexpected travel action different from a planned travel action is assumed, the vehicle image display system cannot be applied to driving support for showing a route up to a destination.

In recent years, the development of vehicles having an automatic driving function has been vigorously performed. For example, a vehicle which can be parked by automatic driving without need for an operation by a driver is commercially available.

However, since in the vehicle having the conventional automatic driving function, it is impossible to previously notify an occupant of what type of behavior the vehicle takes from now by automatic driving, an occupant who is not accustomed to the behavior of the vehicle in automatic driving may have a feeling of fear.

In the vehicle image display system disclosed in Japanese Unexamined Patent Application Publication No. 2016-182891, when the automatic driving system makes the present vehicle take an unexpected travel action different from a planned travel action, the image which visually indicates the unexpected travel action by the virtual vehicle is previously displayed as a prediction. Since in the vehicle image display system disclosed in Japanese Unexamined Patent Application Publication No. 2016-182891, the case where the automatic driving system makes the present vehicle take an unexpected travel action different from a planned travel action is assumed, when the automatic driving system makes the present vehicle take the planned travel action, it is impossible to display the image including the virtual vehicle.

Even in driving other than automatic driving, an occupant who is not accustomed to a vehicle may have a feeling of anxiety when there is no prospect of the future travel of the vehicle.

### SUMMARY OF THE INVENTION

An object of the present invention is to provide a driving support technology with which it is possible to guide the present vehicle to a destination while reducing the burden of a driver or to provide an information providing technology with which it is possible to provide an occupant in the present vehicle to a feeling of security.

According to one aspect of the present invention, a driving support device includes: a generation portion which generates a picture of a first virtual vehicle; and a superimposition portion which superimposes the picture of the first virtual vehicle on a surrounding image showing a vicinity of a present vehicle, where the picture of the first virtual vehicle is moved, ahead of a current position of the present vehicle, along a guide route up to a destination of the present vehicle in the surrounding image.

According to another aspect of the present invention, a driving support method includes: a generation step of generating a picture of a first virtual vehicle; and a superimposition step of superimposing the picture of the first virtual vehicle on a surrounding image showing a vicinity of a present vehicle, where the picture of the first virtual vehicle is moved, ahead of a current position of the present vehicle, along a guide route up to a destination of the present vehicle in the surrounding image.

According to another aspect of the present invention, an information providing device includes: a generation portion which generates a picture of a third virtual vehicle; and a superimposition portion which superimposes the picture of the third virtual vehicle on a surrounding image showing a vicinity of a present vehicle, where the picture of the third virtual vehicle is moved along a planned travel route up to a destination of the present vehicle in the surrounding image and at least one intermediate position is provided on the planned travel route, and when the picture of the third virtual vehicle passes the intermediate position, a picture of a fourth virtual vehicle is superimposed on a position in the surrounding image corresponding to the intermediate position.

According to another aspect of the present invention, an information providing method includes: a generation step of generating a picture of a third virtual vehicle; and a superimposition step of superimposing the picture of the third virtual vehicle on a surrounding image showing a vicinity of a present vehicle, where the picture of the third virtual vehicle is moved along a planned travel route up to a destination of the present vehicle in the surrounding image and at least one intermediate position is provided on the planned travel route, and when the picture of the third virtual vehicle passes the intermediate position, a picture of a fourth virtual vehicle is superimposed on a position in the surrounding image corresponding to the intermediate position.

### BRIEF DESCRIPTION OF THE DRAWINGS

FIG. 1 is a diagram showing an example of the configuration of a driving support device;

FIG. 2 is a diagram illustrating positions in which four vehicle-mounted cameras are arranged in a vehicle;

FIG. 3 is a diagram showing an example of a virtual projection plane;

FIG. 4 is a flowchart showing an example of the operation of the driving support device;

FIG. 5 is a diagram showing an example of an output image;

FIG. 6 is a diagram showing an example of the output image;

FIG. 7 is a diagram showing an example of the output image;

FIG. 8 is a diagram showing an example of the output image;

FIG. 9 is a diagram showing an example of the output image;

FIG. 10 is a diagram showing an example of the output image;

FIG. 11 is a diagram showing an example of the output image;

FIG. 12 is a flowchart showing another example of the operation of the driving support device;

FIG. 13 is a diagram showing an example of a relationship between the speed of the present vehicle and a predetermined value;

FIG. 14 is a diagram showing an example of the relationship between the speed of the present vehicle and the predetermined value;

FIG. 15 is a diagram showing an example of the configuration of an information providing device;

FIG. 16 is a flowchart showing an example of the operation of the information providing device;

FIG. 17 is a diagram showing an example of an output image;

FIG. 18 is a diagram showing an example of the output image;

FIG. 19 is a diagram showing an example of the output image;

FIG. 20 is a diagram showing an example of the output image;

FIG. 21 is a diagram showing an example of the output image;

FIG. 22 is a diagram showing an example of the output image;

FIG. 23 is a diagram showing an example of the output image;

FIG. 24 is a diagram showing an example of the output image; and

FIG. 25 is a diagram showing an example of the output image.

### DESCRIPTION OF THE PREFERRED EMBODIMENTS

Illustrative embodiments of the present invention will be described in detail below with reference to drawings.

### 1. First Embodiment

<1-1. Example of Configuration of Driving Support Device>

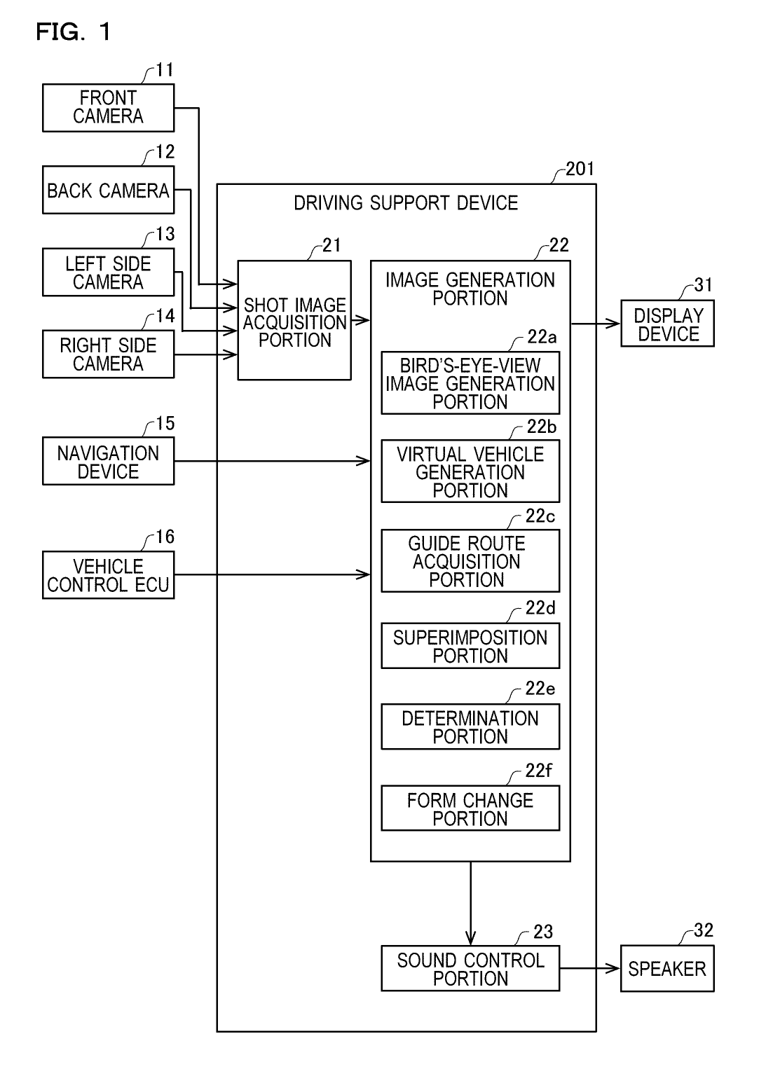

FIG. 1 is a diagram showing an example of the configuration of a driving support device. The driving support device 201 shown in FIG. 1 is mounted in a vehicle such as an automobile. In the following description, the vehicle in which at least one of the driving support device 201 and an information providing device 202 described later is mounted is referred to as the “present vehicle”. A direction which is a linear travel direction of the present vehicle and which extends from a driver seat toward a steering is referred to as a “forward direction”. A direction which is a linear travel direction of the present vehicle and which extends from the steering toward the driver seat is referred to as a “backward direction”. A direction which is perpendicular to the linear travel direction of the present vehicle and a vertical line and which extends from the right side to the left side of a driver who faces in the forward direction is referred to as a “leftward direction”. A direction which is perpendicular to the linear travel direction of the present vehicle and the vertical line and which extends from the left side to the right side of the driver who faces in the forward direction is referred to as a “rightward direction”.

A front camera 11, a back camera 12, a left side camera 13, a right side camera 14, a navigation device 15, a vehicle control ECU 16, the driving support device 201, a display device 31 and a speaker 32 shown in FIG. 1 are mounted in the present vehicle.

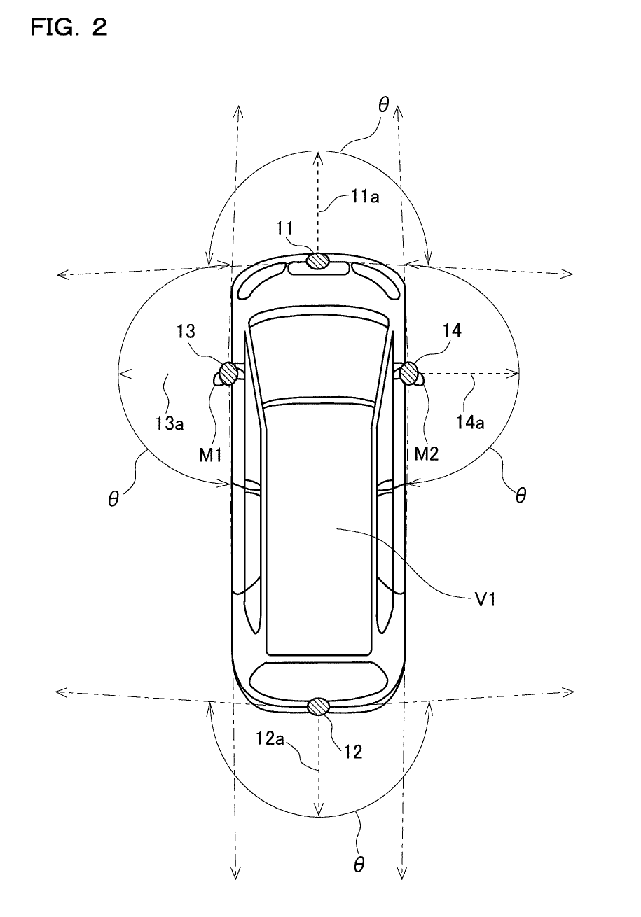

FIG. 2 is a diagram illustrating positions in which the four vehicle-mounted cameras (the front camera 11, the back camera 12, the left side camera 13 and the right side camera 14) are arranged in the present vehicle V1.

The front camera 11 is provided at the front end of the present vehicle V1. The optical axis 11a of the front camera 11 is along the forward/backward direction of the present vehicle V1 in plan view from above. The front camera 11 shoots in the forward direction of the present vehicle V1. The back camera 12 is provided at the back end of the present vehicle V1. The optical axis 12a of the back camera 12 is along the forward/backward direction of the present vehicle V1 in plan view from above. The back camera 12 shoots in the backward direction of the present vehicle V1. Although the positions in which the front camera 11 and the back camera 12 are attached are preferably in the center of the present vehicle V1 in a left/right direction, the positions may be slightly displaced from the center in the left/right direction toward the left/right direction.

The left side camera 13 is provided in the left-side door mirror M1 of the present vehicle V1. The optical axis 13a of the left side camera 13 is along the left/right direction of the present vehicle V1 in plan view from above. The left side camera 13 shoots in the leftward direction of the present vehicle V1. The right side camera 14 is provided in the right-side door mirror M2 of the present vehicle V1. The optical axis 14a of the right side camera 14 is along the left/right direction of the present vehicle V1 in plan view from above. The right side camera 14 shoots in the rightward direction of the present vehicle V1. When the present vehicle V1 is a so-called door mirrorless vehicle, the left side camera 13 is attached around the rotary shaft (hinge portion) of a left side door without intervention of the door mirror, and the right side camera 14 is attached around the rotary shaft (hinge portion) of a right side door without intervention of the door mirror.

The angle of view θ of each of the vehicle-mounted cameras in a horizontal direction is equal to or more than 180 degrees. Thus, it is possible to shoot all around the present vehicle V1 in the horizontal direction with the four vehicle-mounted cameras (the front camera 11, the back camera 12, the left side camera 13 and the right side camera 14). Although in the present embodiment, the number of vehicle-mounted cameras is set to four, the number of vehicle-mounted cameras necessary for producing a bird's-eye-view image described later with images shot by the vehicle-mounted cameras is not limited to four as long as a plurality of cameras are used. As an example, when the angle of view θ of each of the vehicle-mounted cameras in the horizontal direction is relatively wide, based on three shot images acquired from three cameras which are less than four cameras, a bird's-eye-view image may be generated. Furthermore, as another example, when the angle of view 0 of each of the vehicle-mounted cameras in the horizontal direction is relatively narrow, based on five shot images acquired from five cameras which are more than four cameras, a bird's-eye-view image may be generated.

With reference back to FIG. 1, the four vehicle-mounted cameras (the front camera 11, the back camera 12, the left side camera 13 and the right side camera 14) output the shot images to the driving support device 201. The navigation device 15 outputs the current position information of the present vehicle and map information to the driving support device 201. The vehicle control ECU 16 outputs the speed information of the present vehicle to the driving support device 201. Instead of the vehicle control ECU 16, a vehicle speed sensor may directly output the speed information of the present vehicle to the driving support device 201.

The driving support device 201 processes the shot images output from the four vehicle-mounted cameras (the front camera 11, the back camera 12, the left side camera 13 and the right side camera 14), and outputs the processed images to the display device 31. The driving support device 201 performs control so as to output a sound from the speaker 32.

The display device 31 is provided in such a position that the driver of the present vehicle can visually recognize the display screen of the display device 31, and displays the images output from the driving support device 201. Examples of the display device 31 include a display installed in a center console, a meter display installed in a position opposite the driver seat and a head-up display which projects an image on a windshield.

The speaker 32 outputs the sound according to the control of the driving support device 201.

The driving support device 201 can be formed with hardware such as an ASIC (application specific integrated circuit) or an FPGA (field-programmable gate array) or with a combination of hardware and software. When the driving support device 201 is formed with software, a block diagram of a portion realized by the software indicates a functional block diagram of the portion. A function realized with the software is described as a program, and the program is executed on a program execution device, with the result that the function may be realized. As the program execution device, for example, a computer which includes a CPU (Central Processing Unit), a RAM (Random Access Memory) and a ROM (Read Only Memory) can be mentioned.

The driving support device 201 includes a shot image acquisition portion 21, an image generation portion 22 and a sound control portion 23.

The shot image acquisition portion 21 acquires, from the four vehicle-mounted cameras (the front camera 11, the back camera 12, the left side camera 13 and the right side camera 14), analogue or digital shot images at a predetermined period (for example, a period of 1/30 seconds) continuously in time. Then, when the acquired shot images are analogue, the shot image acquisition portion 21 converts (A/D conversion) the analogue shot images into digital shot images. The shot image acquisition portion 21 outputs the acquired shot images or the shot images acquired and converted to the image generation portion 22.

The image generation portion 22 includes a bird's-eye-view image generation portion 22a, a virtual vehicle generation portion 22b, a guide route acquisition portion 22c, a superimposition portion 22d, a determination portion 22e and a form change portion 22f.

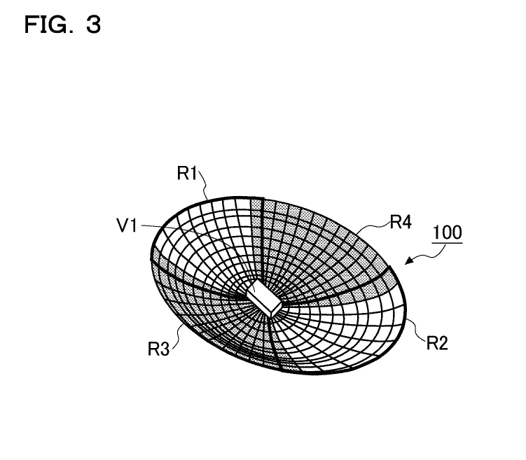

The bird's-eye-view image generation portion 22a projects the shot images acquired by the shot image acquisition portion 21 on a virtual projection plane, and converts them into projection images. Specifically, the bird's-eye-view image generation portion 22a projects the shot image of the front camera 11 on the first region R1 of the virtual projection plane 100 in a virtual three-dimensional space shown in FIG. 3, and converts the shot image of the front camera 11 into a first projection image. Likewise, the bird's-eye-view image generation portion 22a respectively projects the shot image of the back camera 12, the shot image of the left side camera 13 and the shot image of the right side camera 14 on the second to fourth regions R2 to R4 of the virtual projection plane 100 shown in FIG. 3, and respectively converts the shot image of the back camera 12, the shot image of the left side camera 13 and the shot image of the right side camera 14 into second to fourth projection images.

The virtual projection plane 100 shown in FIG. 3 has, for example, a substantially hemispherical shape (bowl shape). The center portion (the bottom portion of the bowl) of the virtual projection plane 100 is determined to be a position in which the present vehicle V1 is present. The virtual projection plane 100 is made to include the curved plane as described above, and thus it is possible to reduce the distortion of a picture of an object which is present in a position away from the present vehicle V1. Each of the first to fourth regions R1 to R4 includes portions which overlap the other adjacent regions. The overlapping portions as described above are provided, and thus it is possible to prevent the picture of the object projected on the boundary portion of the regions from disappearing.

The bird's-eye-view image generation portion 22a generates, based on a plurality of projection images, a virtual viewpoint image seen from a virtual viewpoint. Specifically, the bird's-eye-view image generation portion 22a virtually adheres the first to fourth projection images to the first to fourth regions R1 to R4 in the virtual projection plane 100.

The bird's-eye-view image generation portion 22a virtually configures a polygon model showing the three-dimensional shape of the present vehicle V1. The model of the present vehicle V1 is arranged, in the virtual three-dimensional space where the virtual projection plane 100 is set, in the position (the center portion of the virtual projection plane 100) which is determined to be the position where the present vehicle V1 is present such that the first region R1 is the front side and the fourth region R4 is the back side.

Furthermore, the bird's-eye-view image generation portion 22a sets the virtual viewpoint in the virtual three-dimensional space where the virtual projection plane 100 is set. The virtual viewpoint is specified by a viewpoint position and a view direction. As long as at least part of the virtual projection plane 100 enters the view, the viewpoint position and the view direction of the virtual viewpoint can be set to an arbitrary viewpoint position and an arbitrary view direction. In the present embodiment, the viewpoint position of the virtual viewpoint is assumed to be located backward and upward of the present vehicle, and the view direction of the virtual viewpoint is assumed to be located forward and downward of the present vehicle. In this way, the virtual viewpoint image generated by the bird's-eye-view image generation portion 22a becomes a bird's-eye-view image. The viewpoint position of the virtual viewpoint is assumed to be located backward and upward of the present vehicle, the view direction of the virtual viewpoint is assumed to be located forward and downward of the present vehicle and thus the driver can more accurately confirm a relationship between the current position of the present vehicle and the position of a first virtual vehicle which will be described later. Unlike the present embodiment, for example, the viewpoint position may be assumed to be the position of the eyes of a standard driver, and the view direction may be assumed to be located forward of the present vehicle.

The bird's-eye-view image generation portion 22a virtually cuts out, according to the set virtual viewpoint, the image of a region (the region seen from the virtual viewpoint) necessary for the virtual projection plane 100. The bird's-eye-view image generation portion 22a also performs, according to the set virtual viewpoint, rendering on the polygon model so as to generate a rendering picture of the present vehicle V1. Then, the bird's-eye-view image generation portion 22a generates a bird's-eye-view image in which the rendering picture of the present vehicle V1 is superimposed on the image that is cut out. In other words, the bird's-eye-view image generation portion 22a generates the picture indicating the present vehicle. The rendering picture of the present vehicle V1 (the picture indicating the present vehicle) is superimposed on the current position of the present vehicle in the bird's-eye-view image.

The virtual vehicle generation portion 22b uses CG (Computer Graphics) so as to generate the picture of the virtual vehicle. The rendering picture of the present vehicle V1 is also a picture of the virtual vehicle, and thus hereinafter, the picture of the virtual vehicle generated by the virtual vehicle generation portion 22b is referred to as the “picture of a first virtual vehicle” and the rendering picture of the present vehicle V1 is referred to as the “picture of a second virtual vehicle”.

The guide route acquisition portion 22c acquires information (guide route information) on a guide route from the current position of the present vehicle to a destination. For example, the guide route acquisition portion 22c may acquire the guide route information as a result of the generation of the guide route information by the guide route acquisition portion 22c itself from the current position of the present vehicle and the map information or when the destination coincides with a destination which is set in the navigation device 15, the guide route acquisition portion 22c may acquire the guide route information from the navigation device 15.

The superimposition portion 22d superimposes the picture of the first virtual vehicle on the bird's-eye-view image. The picture of the first virtual vehicle is moved, ahead of the current position of the present vehicle, along the guide route up to the destination of the present vehicle in the bird's-eye-view image. Specifically, the picture of the first virtual vehicle is superimposed on a position corresponding to a position to which the present vehicle needs to travel from now along the guide route up to the destination of the present vehicle in the bird's-eye-view image. As the present vehicle travels, the current position of the present vehicle and the position to which the present vehicle needs to travel from now are varied.

The determination portion 22e determines whether or not the current position of the present vehicle, that is, the picture of the second virtual vehicle follows the picture of the first virtual vehicle.

The form change portion 22f changes the form of the picture of the first virtual vehicle according to the result of the determination by the determination portion 22e.

The sound control portion 23 makes the speaker 32 generate, for example, a notification sound for notifying that the picture of the first virtual vehicle appears or disappears when the picture of the first virtual vehicle appears or disappears.

<1-2. Example of Operation of Driving Support Device>

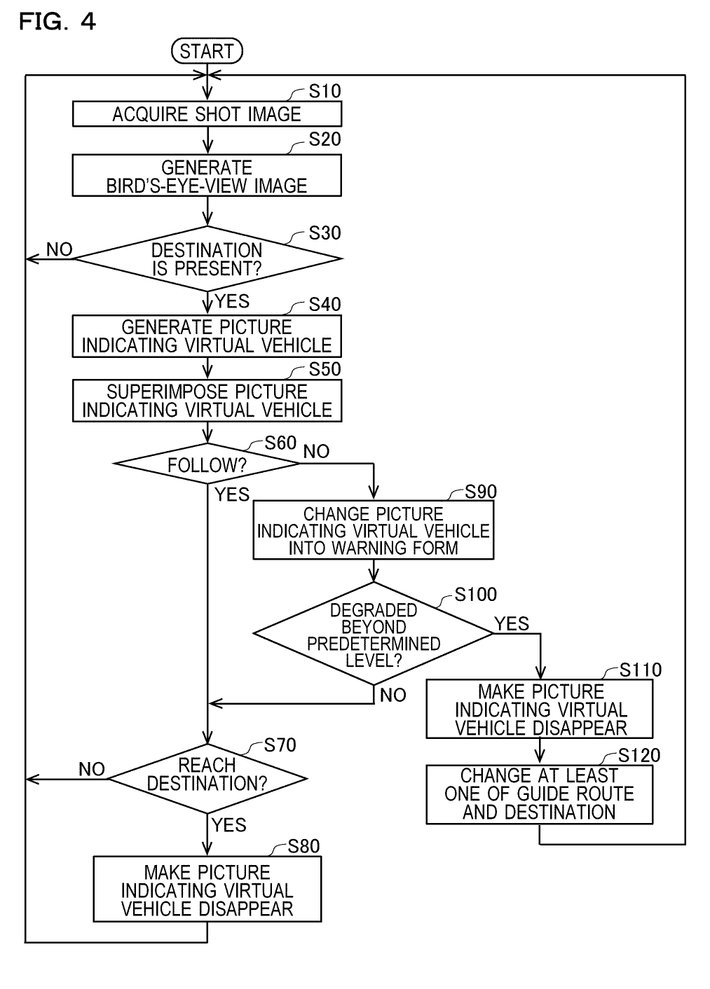

FIG. 4 is a flowchart showing an example of the operation of the driving support device 201. The driving support device 201 starts a flow operation shown in FIG. 4 after the completion of the startup of the driving support device 201.

When the flow operation shown in FIG. 4 is started, the shot image acquisition portion 21 first acquires the shot images from the four vehicle-mounted cameras (the front camera 11, the back camera 12, the left side camera 13 and the right side camera 14) (step S10).

Then, the bird's-eye-view image generation portion 22a uses the shot images acquired by the shot image acquisition portion 21 so as to generate the bird's-eye-view image (step S20).

Then, the image generation portion 22 determines whether or not the destination is present (step S30). The destination may be set by providing an operation portion in the driving support device 201 and performing an input operation with the operation portion or may be automatically set as the guiding is performed by the navigation device 15.

For example, when an instruction to perform a left turn at an intersection is provided by the navigation device 15, a slightly advanced position after the completion of the left turn at the intersection may be set to the destination in the driving support device 201. For example, when the destination of the guiding by the navigation device 15 is a predetermined parking lot, a position adjacent to a ticket issuing machine installed in the entrance of the predetermined parking lot or a parking position within the predetermined parking lot may be set to the destination in the driving support device 201.

Preferably, the destination in the driving support device 201 is automatically changed according to the surrounding situation of the present vehicle and the like. For example, preferably, when the driving support device 201 detects an obstacle, such as a two-wheeled vehicle, which approaches from leftwardly behind the present vehicle at the time of a left turn, the destination in the driving support device 201 is changed from a slightly advanced position after the completion of the left turn at the intersection to a position in front of the intersection, and after the confirmation of the passage of the obstacle, the destination in the driving support device 201 is returned to the slightly advanced position after the completion of the left turn at the intersection. In the detection of the obstacle, for example, the shot image of the vehicle-mounted camera can be used or information which is output from a radar device mounted in the present vehicle or information which can be obtained by communication with a cloud center, vehicle-to-vehicle communication, road-to-vehicle communication or the like can be used.

When the destination is not present, the process is returned to step S10 whereas when the destination is present, the process is transferred to step S40. In the following description, the destination in the driving support device 201 is assumed to be a position adjacent to a ticket issuing machine installed in the entrance of a predetermined parking lot.

In step S40, the virtual vehicle generation portion 22b generates the picture of the first virtual vehicle.

In step S50 subsequent to step S40, the superimposition portion 22d superimposes the picture of the first virtual vehicle on the bird's-eye-view image.

In the present embodiment, the superimposition portion 22d superimposes the picture of the first virtual vehicle on the bird's-eye-view image such that in the bird's-eye-view image, the picture of the first virtual vehicle appears in the current position of the present vehicle and is thereafter moved along the guide route to the position to which the present vehicle needs to travel from now.

Specifically, when in a state where the picture of the first virtual vehicle is not superimposed on the bird's-eye-view image, processing in step S50 is performed, the picture of the first virtual vehicle is superimposed on a position in the bird's-eye-view image corresponding to the current position of the present vehicle. Hence, by the processing in step S50, the bird's-eye-view image output from the driving support device 201 to the display device 31 is changed, for example, from a bird's-eye-view image shown in FIG. 5 to a bird's-eye-view image shown in FIG. 6. On the bird's-eye-view image shown in FIG. 5, the rendering picture (the picture of the second virtual vehicle) VR1 of the present vehicle is superimposed, and on the bird's-eye-view image shown in FIG. 6, the rendering picture VR1 of the present vehicle and a picture V2 of the first virtual vehicle are superimposed. The picture V2 of the first virtual vehicle is a picture which is transparent.

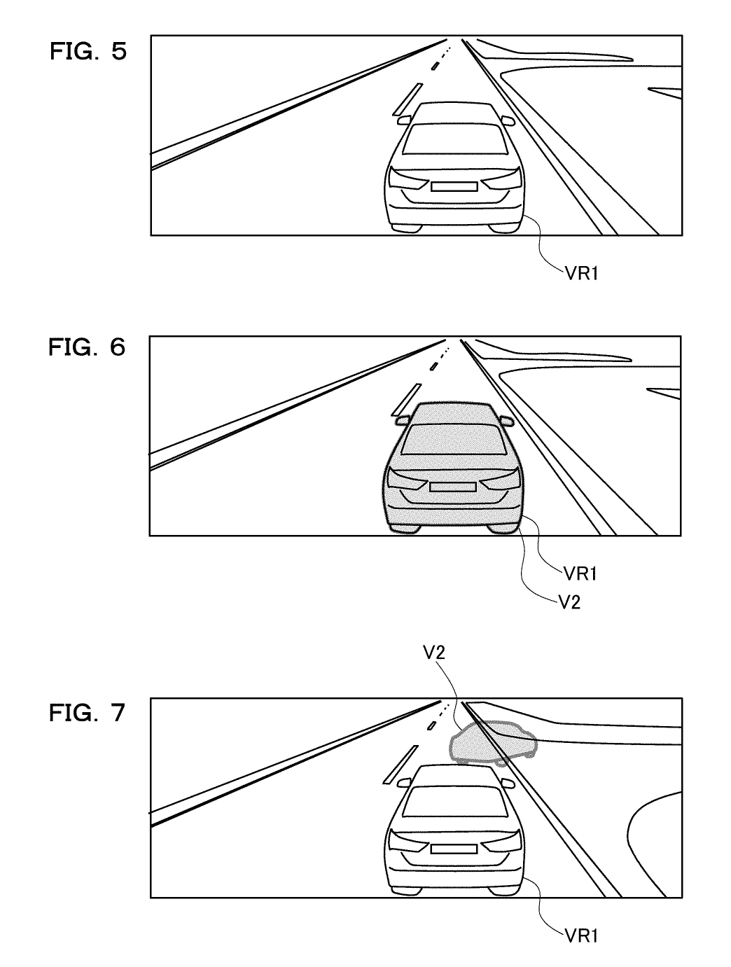

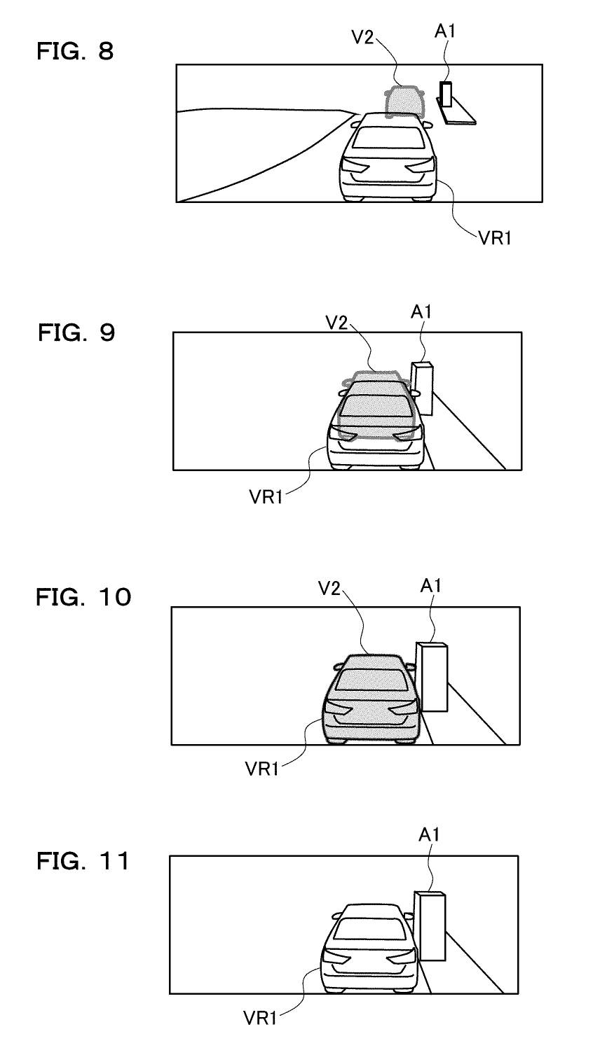

On the other hand, when in a state where the picture of the first virtual vehicle is already superimposed on the bird's-eye-view image, the processing in step S50 is performed, the picture of the first virtual vehicle is superimposed on a position in the bird's-eye-view image corresponding to the position (the position ahead of the current position of the present vehicle on the guide route) to which the present vehicle needs to travel from now. Hence, the processing in step S50 is repeated, and thus the bird's-eye-view image output from the driving support device 201 to the display device 31 is changed, for example, from the bird's-eye-view image shown in FIG. 6 to a bird's-eye-view image shown in FIG. 7. Thereafter, when the picture of the first virtual vehicle comes to the destination in the bird's-eye-view image, the picture of the first virtual vehicle is stopped in the position of the destination (see FIGS. 8 to 10 which will be described later).

At the beginning of the appearance of the picture of the first virtual vehicle, the speed of the first virtual vehicle is increased as compared with the speed of the present vehicle, and thus the picture of the first virtual vehicle is moved from the current position of the present vehicle to the position to which the present vehicle needs to travel from now. Then, when the first virtual vehicle is a predetermined distance ahead of the present vehicle on the guide route, the speed of the first virtual vehicle is made equal to the speed of the present vehicle, and thus the first virtual vehicle is prevented from being excessively separated from the present vehicle.

As described above, since the first virtual vehicle is present in the position to which the present vehicle needs to travel from now, the first virtual vehicle serves as a leading vehicle for the present vehicle. Hence, it is possible to drive while following the first virtual vehicle, and thus it is possible to guide the present vehicle to the destination while reducing the burden of the driver.

Since as described above, the second virtual vehicle and the first virtual vehicle are included in the bird's-eye-view image, the driver can intuitively grasp a relationship between the current position of the present vehicle and the position of the first virtual vehicle. Hence, it is easy to drive while following the first virtual vehicle.

As described above, the picture of the first virtual vehicle appears in the current position of the present vehicle and is thereafter moved along the guide route to the position to which the present vehicle needs to travel from now, and thus it appears as if the first virtual vehicle was separated ahead of the present vehicle, with the result that the driver can intuitively grasp the information that the travel route of the first virtual vehicle is the route on which the present vehicle needs to travel.

In step S60 subsequent to step S50, the determination portion 22e determines whether or not the current position of the present vehicle, that is, the picture of the second virtual vehicle follows the picture of the first virtual vehicle. Specifically, when the present vehicle is separated, in a vehicle width direction, a first threshold value or more from on the travel route of the first virtual vehicle, that is, the guide route acquired from the guide route acquisition portion 22c, the determination portion 22e determines that the current position of the present vehicle does not follow the picture of the first virtual vehicle. The driving support device 201 stores the first threshold value in a nonvolatile manner.

When the current position of the present vehicle follows the picture of the first virtual vehicle, the process is transferred to step S70. In step S70, the image generation portion 22 determines, based on the current position of the present vehicle, whether or not the current position of the present vehicle reaches the destination.

When the current position of the present vehicle does not reach the destination, the process is immediately returned to step S10. On the other hand, when the current position of the present vehicle reaches the destination, the picture of the first virtual vehicle is overlaid on the picture of the second virtual vehicle, immediately after they are overlaid on each other, the superimposition portion 22 makes the picture of the first virtual vehicle disappear from the bird's-eye-view image (step S80), the image generation portion 22 resets the setting of the destination and then the process is returned to step S10. It is likely that immediately after the setting of the destination is reset, the subsequent destination is set or is not set. Hence, processing in step S80 is performed, and thus in a period from immediately before the present vehicle reaches the destination to immediately after the present vehicle reaches the destination, the bird's-eye-view image output from the driving support device 201 to the display device 31 is sequentially changed, for example, from a bird's-eye-view image shown in FIG. 8 to a bird's-eye-view image shown in FIG. 9 to a bird's-eye-view image shown in FIG. 10 and to a bird's-eye-view image shown in FIG. 11. The position adjacent to the ticket issuing machine A1 in the bird's-eye-view image shown in FIGS. 8 to 11 is the position of the destination.

As described above, even when the picture of the first virtual vehicle reaches the destination, the picture indicating the virtual vehicle does not disappear until the present vehicle reaches the destination. In this way, it is easy for the driver to accurately stop the present vehicle in the position of the destination. For example, in the present example where the position adjacent to the ticket issuing machine A1 is the position of the destination, the driving support device 201 is particularly useful because when the present vehicle is only several tens of centimeters displaced from the position of the destination, it is difficult to take a parking ticket.

As described above, immediately after the picture of the first virtual vehicle and the picture of the second virtual vehicle are overlaid on each other, the picture of the first virtual vehicle disappears from the bird's-eye-view image, and thus the driver can intuitively grasp the information that the present vehicle accurately stops in the position of the destination.

In the determination processing in step S60, when it is determined that the current position of the present vehicle does not follow the picture of the first virtual vehicle, the process is transferred to step S90.

In step S90, the image generation portion 22 changes the picture of the first virtual vehicle such that the picture of the first virtual vehicle has a form for warning. The form for warning is maintained until the follow of the picture of the first virtual vehicle by the current position of the present vehicle is restored. Examples of a combination between the form for non-warning and the form for warning include a combination between the form for non-warning that is a yellow display which is transparent and the form for warning that is a red display which is transparent and a combination between the form for non-warning that is a non-flashing display and the form for warning that is a flashing display.

As described above, the form of the picture of the first virtual vehicle is changed according to the result of the determination in the determination processing of step S60, and thus the driver can intuitively grasp the fact that the present vehicle travels off the guide route, with the result that it is possible to guide the driving operation of the driver to the proper driving operation.

In step S100 subsequent to step S90, the determination portion 22e determines whether or not the state where the current position of the present vehicle does not follow the picture of the first virtual vehicle is degraded beyond a predetermined level. For example, when the state where the current position of the present vehicle does not follow the picture indicating the virtual vehicle is continued for a predetermined period, the state may be determined to be degraded beyond the predetermined level or when the present vehicle is separated, in the vehicle width direction, a second threshold value or more from on the guide route, the state may be determined to be degraded beyond the predetermined level. The second threshold value is a value which is more than the first threshold value.

When the state where the current position of the present vehicle does not follow the picture of the first virtual vehicle is not degraded beyond the predetermined level, the process is transferred to step S70. On the other hand, when the state where the current position of the present vehicle does not follow the picture of the first virtual vehicle is degraded beyond the predetermined level, the superimposition portion 22 makes the picture of the first virtual vehicle disappear from the bird's-eye-view image (step S110), the driving support device 201 changes at least one of the guide route and the destination (step S120) and thereafter the process is returned to step S10. The change in step S120 includes the case where the guide route or the destination is removed.

When as described above, the state where the current position of the present vehicle does not follow the picture of the first virtual vehicle is degraded beyond the predetermined level, the picture of the first virtual vehicle is made to disappear from the bird's-eye-view image, and thus it is possible to prevent the occurrence of needless guiding by the first virtual vehicle.

<1-3. Others>

In addition to the first embodiment described above, various variations can be added to various technical features disclosed in the present specification without departing from the split of the technical creation thereof. A plurality of variations described in the present specification may be combined and practiced if possible.

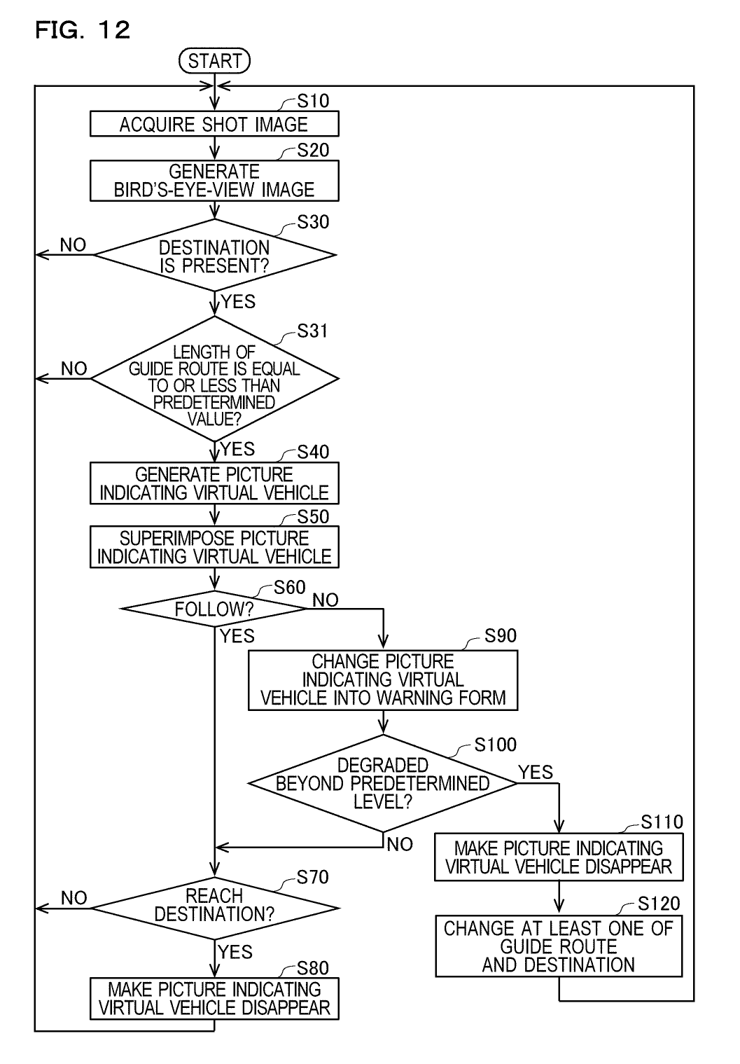

For example, the driving support device 201 may perform, instead of the flow operation shown in FIG. 4, a flow operation shown in FIG. 12. The flowchart shown in FIG. 12 is obtained by adding step S31 to the flowchart shown in FIG. 4. Step S31 is provided between step S30 and step S40.

In step S31, the image generation portion 22 determines whether or not the length of the guide route is equal to or less than a predetermined value. When the length of the guide route is not equal to or less than the predetermined value, the process is returned to step S10 whereas when the length of the guide route is equal to or less than the predetermined value, the process is transferred to step S40. In this way, it is possible to make the picture of the first virtual vehicle appear with appropriate timing (the timing at which the guiding by the virtual vehicle is needed).

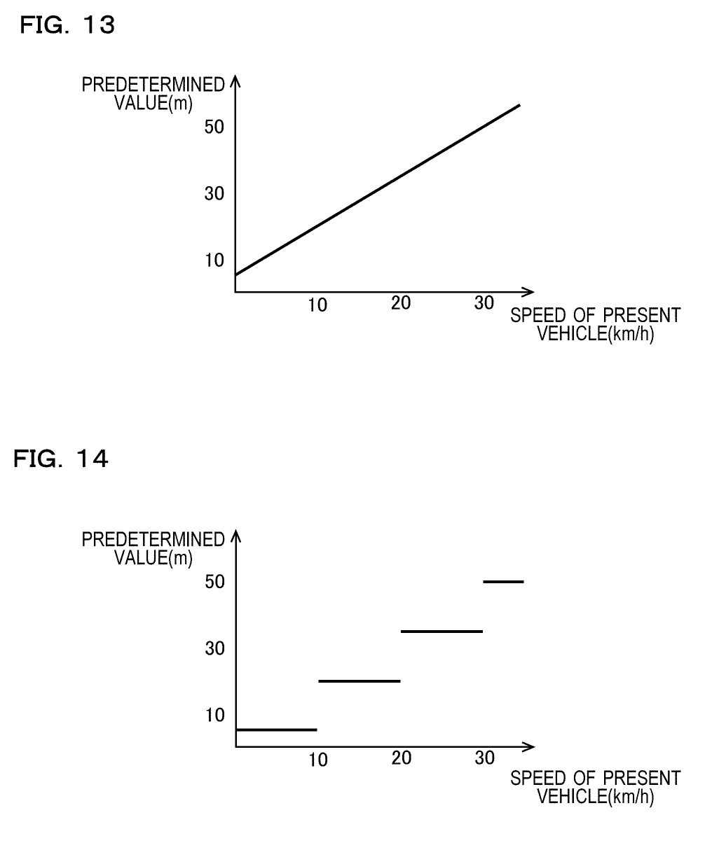

The predetermined value used in step S31 is preferably varied according to the speed of the present vehicle. For example, the image generation portion 22 stores a relationship shown in FIG. 13 between the speed of the present vehicle and the predetermined value in the form of a data table or a relational formula in a nonvolatile manner, acquires the speed information of the present vehicle from the vehicle control ECU 16 and changes the predetermined value based on the acquired information. The relationship between the speed of the present vehicle and the predetermined value is not limited to the relationship in which the predetermined value is continuously changed with respect to the speed of the present vehicle as shown in FIG. 13, and may be, for example, a relationship in which the predetermined value is not continuously changed with respect to the speed of the present vehicle as shown in FIG. 14.

Although in the first embodiment described above, the position in which the picture of the first virtual vehicle appears is the current position of the present vehicle, the position in which the picture of the first virtual vehicle appears may be, from the beginning of the appearance, the position to which the present vehicle needs to travel from now.

Although in the first embodiment described above, the shot image is used for the generation of the image (the output image) output from the driving support device 201 to the display device 31, CG (Computer Graphics) showing the vicinity of the present vehicle may be used without use of the shot image so as to generate the output image. When the CG showing the vicinity of the present vehicle is used so as to generate the output image, the driving support device 201 preferably acquires the CG showing the vicinity of the present vehicle from, for example, the navigation device 15.

Although in the first embodiment described above, the direction in which the present vehicle travels is the forward direction, the present invention can also be applied to a case where the direction in which the present vehicle travels is the backward direction.

In the output image output from the driving support device 201 to the display device 31, the vehicle speed information of the present vehicle, the range information of a shift lever in the present vehicle and the like may be included.

Although in the first embodiment described above, not only the picture of the first virtual vehicle but also the picture of the second virtual vehicle is also superimposed on the bird's-eye-view image such that the driver can intuitively grasp a relationship between the current position of the present vehicle and the position of the first virtual vehicle, a configuration may be adopted in which the picture of the second virtual vehicle is not superimposed on the bird's-eye-view image.

Although in the first embodiment described above, the output image output by the driving support device is the bird's-eye-view image, the output image output by the driving support device is not limited to the bird's-eye-view image, and for example, the picture of the first virtual vehicle or the like may be superimposed on the shot image of the front camera 11.

### 2. Second Embodiment

<2-1. Example of Configuration of Information Providing Device>

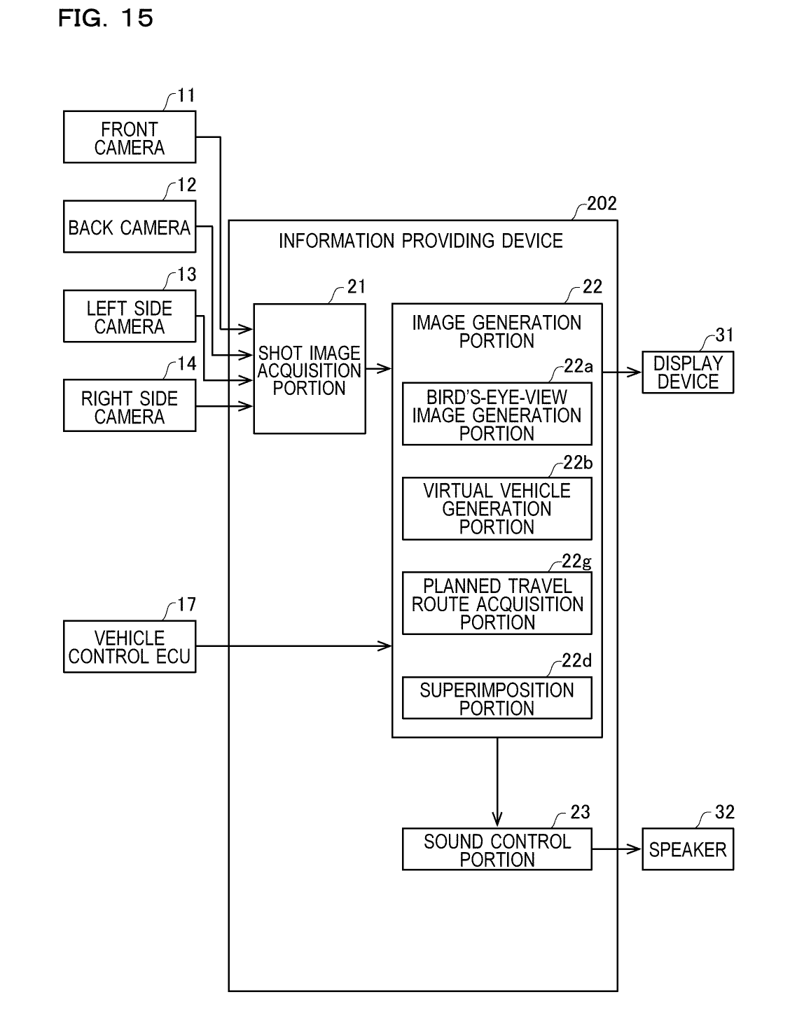

FIG. 15 is a diagram showing an example of the configuration of an information providing device. The information providing device 202 shown in FIG. 15 is mounted in a vehicle such as an automobile. In FIG. 15, the same portions as in FIG. 1 are identified with the same symbols, and the detailed description thereof will be omitted.

The front camera 11, the back camera 12, the left side camera 13, the right side camera 14, a vehicle control ECU 17, the information providing device 202, the display device 31 and the speaker 32 shown in FIG. 15 are mounted in the present vehicle.

The positions to which the front camera 11, the back camera 12, the left side camera 13 and the right side camera 14 are attached and the like are the same as in the first embodiment.

The four vehicle-mounted cameras (the front camera 11, the back camera 12, the left side camera 13 and the right side camera 14) output the shot images to the information providing device 202. The vehicle control ECU 17 outputs control information on the automatic driving of the present vehicle to the information providing device 202. The vehicle control ECU 17 uses, for example, the result of analysis of the shot images by the vehicle-mounted cameras, information which is output from a radar device mounted in the present vehicle or information which can be obtained by communication with a cloud center, vehicle-to-vehicle communication, road-to-vehicle communication or the like so as to plan a planned travel route in the automatic driving.

The information providing device 202 processes the shot images output from the four vehicle-mounted cameras (the front camera 11, the back camera 12, the left side camera 13 and the right side camera 14), and outputs the processed images to the display device 31. The information providing device 202 performs control so as to output a sound from the speaker 32.

The information providing device 202 can be formed with hardware such as an ASIC (application specific integrated circuit) or an FPGA (field-programmable gate array) or with a combination of hardware and software. When the information providing device 202 is formed with software, a block diagram of a portion realized by the software indicates a functional block diagram of the portion. A function realized with the software is described as a program, and the program is executed on a program execution device, with the result that the function may be realized. As the program execution device, for example, a computer which includes a CPU (Central Processing Unit), a RAM (Random Access Memory) and a ROM (Read Only Memory) can be mentioned.

The information providing device 202 includes the shot image acquisition portion 21, the image generation portion 22 and the sound control portion 23.

The image generation portion 22 in the present embodiment includes the bird's-eye-view image generation portion 22a, the virtual vehicle generation portion 22b, a planned travel route acquisition portion 22g and the superimposition portion 22d.

The bird's-eye-view image generation portion 22a and the virtual vehicle generation portion 22b in the present embodiment are the same as the bird's-eye-view image generation portion 22a and the virtual vehicle generation portion 22b in the first embodiment. In the present embodiment, the picture of the virtual vehicle generated by the virtual vehicle generation portion 22b is referred to as the “picture of a third virtual vehicle”.

The planned travel route acquisition portion 22g acquires information (planned travel route information) on the planned travel route from the current position of the present vehicle when the automatic driving is performed to the destination. For example, the planned travel route acquisition portion 22g acquires the planned travel route information from the vehicle control ECU 17.

The superimposition portion 22d superimposes the picture of the third virtual vehicle on the bird's-eye-view image. The picture of the third virtual vehicle is moved, in the bird's-eye-view image, along the planned travel route up to the destination of the present vehicle when the automatic driving is performed. Specifically, in the bird's-eye-view image, along the planned travel route up to the destination of the present vehicle when the automatic driving is performed, the picture of the third virtual vehicle is superimposed on a position corresponding to the position to which the present vehicle in the bird's-eye-view image performs the automatic driving so as to travel from now.

For example, during a period in which the third virtual vehicle is moved in the bird's-eye-view image, the sound control portion 23 makes the speaker 32 generate a notification sound (for example, an electronic sound of a constant rhythm) for notifying that the third virtual vehicle is being moved.

<2-2. Example of Operation of Information Providing Device>

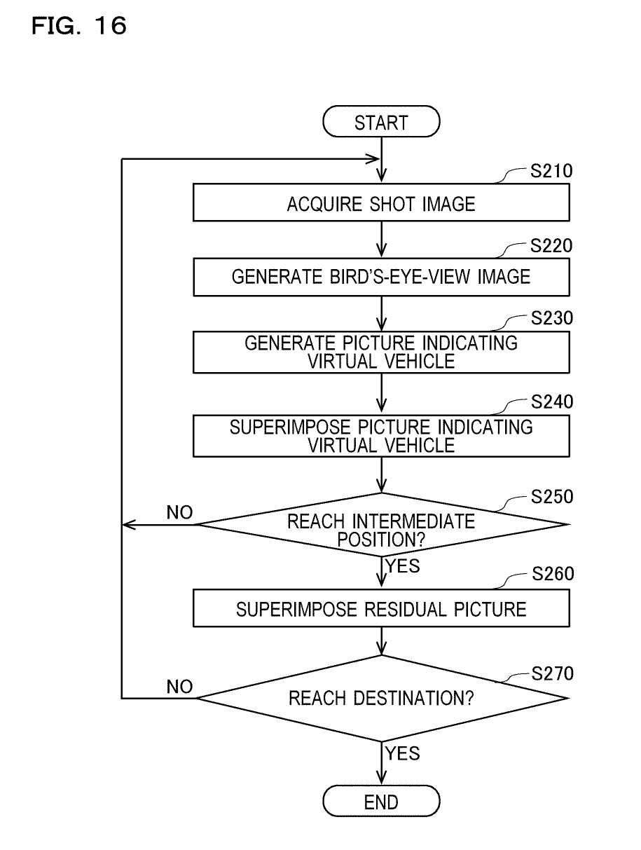

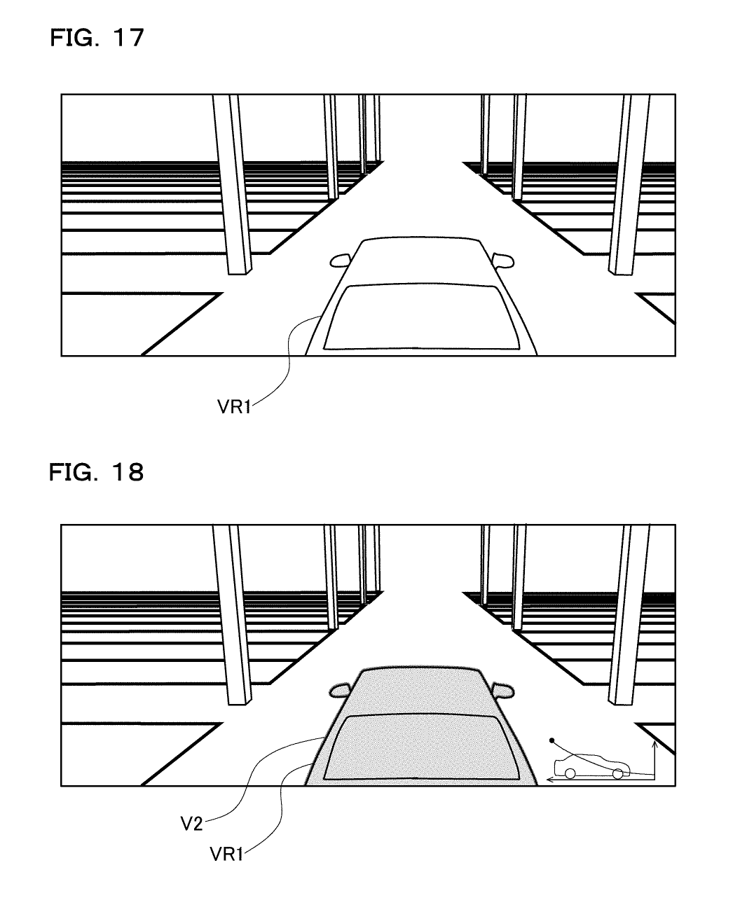

FIG. 16 is a flowchart showing an example of the operation of the information providing device 202. The information providing device 202 starts a flow operation shown in FIG. 16 immediately before the present vehicle performs the automatic driving. In the present embodiment, it is assumed that the present vehicle performs the automatic driving so as to perform automatic parking. Hence, in the present embodiment, a parking position is the destination.

When the flow operation shown in FIG. 16 is started, the shot image acquisition portion 21 first acquires the shot images from the four vehicle-mounted cameras (the front camera 11, the back camera 12, the left side camera 13 and the right side camera 14) (step S210).

Then, the bird's-eye-view image generation portion 22a uses the shot images acquired by the shot image acquisition portion 21 so as to generate the bird's-eye-view image (step S220). In the bird's-eye-view images of FIGS. 17 to 25 which will be described later, the illustration of the parked vehicle is omitted.

Then, the virtual vehicle generation portion 22b generates the picture of the third virtual vehicle (step S230).

Then, the superimposition portion 22d superimposes the picture of the third virtual vehicle on the bird's-eye-view image (step S240).

In the present embodiment, the superimposition portion 22d superimposes the picture of the third virtual vehicle on the bird's-eye-view image such that in the bird's-eye-view image, the picture of the third virtual vehicle appears in the current position of the present vehicle and is thereafter moved along the planned travel route up to the destination of the present vehicle.

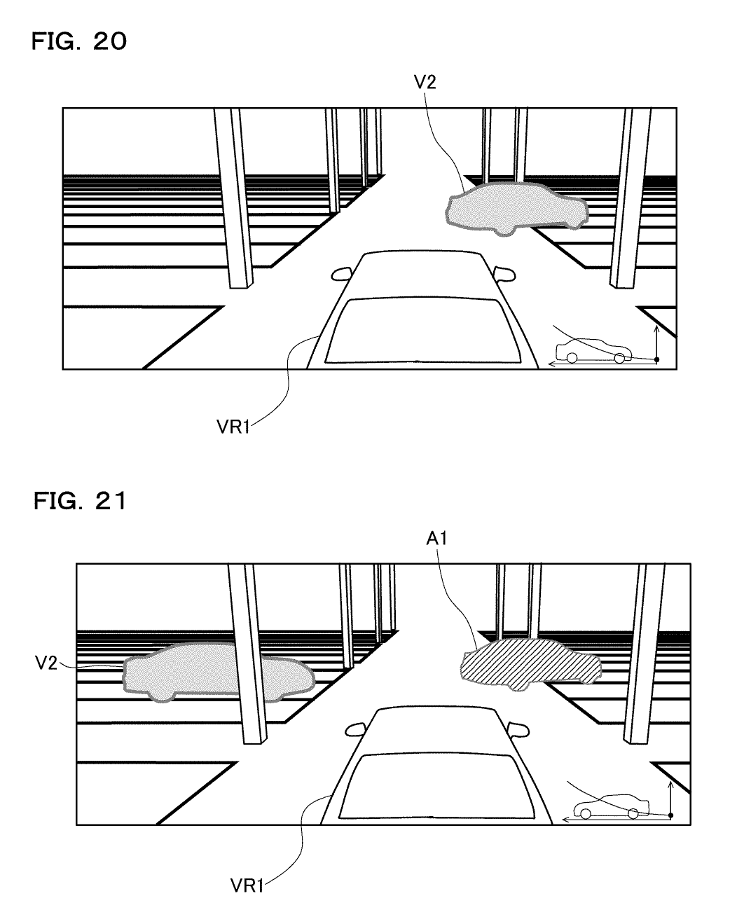

Specifically, when in a state where the picture of the third virtual vehicle is not superimposed on the bird's-eye-view image, processing in step S24 is performed, the picture of the third virtual vehicle is superimposed on a position in the bird's-eye-view image corresponding to the current position of the present vehicle. Hence, the processing in step S24 is performed, and thus the bird's-eye-view image output from the information providing device 202 to the display device 31 is changed, for example, from a bird's-eye-view image shown in FIG. 17 to a bird's-eye-view image shown in FIG. 18. On the bird's-eye-view image shown in FIG. 17, the rendering picture VR1 of the present vehicle is superimposed, and on the bird's-eye-view image shown in FIG. 18, the rendering picture VR1 of the present vehicle and the picture V2 of the third virtual vehicle are superimposed. Although the picture V2 of the third virtual vehicle is not shown in FIGS. 20 to 23 described later so as to be transparent, the picture V2 is actually transparent.

When the image generation portion 22 superimposes the picture V2 of the third virtual vehicle on the bird's-eye-view image, the image generation portion 22 also superimposes, on the lower left corner of the bird's-eye-view image shown in FIG. 18, a graph in which the horizontal axis represents a distance from the position of the third virtual vehicle in the bird's-eye-view image to a stop position in the automatic driving and in which the vertical axis represents the speed of the present vehicle in the automatic driving in the position of the third virtual vehicle in the bird's-eye-view image. The orientation of the vehicle within the graph indicates the direction in which the third virtual vehicle travels to the stop position, and indicates, in FIG. 18, that the third virtual vehicle travels forward to the stop position. A black dot within the graph indicates the state (the position and the speed) of the third virtual vehicle. By the graph, it is possible to previously and more clearly notify an occupant in the present vehicle of what type of behavior the present vehicle takes in the automatic driving from now.

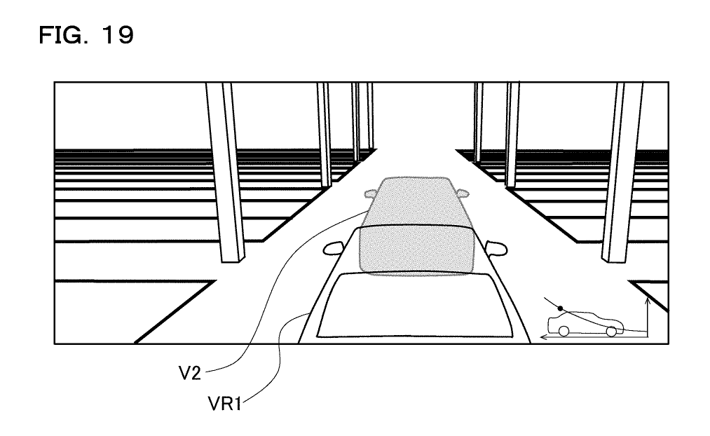

On the other hand, when in a state where the picture of the third virtual vehicle is superimposed on the bird's-eye-view image, the processing in step S240 is performed, the picture of the third virtual vehicle is superimposed on a position in the bird's-eye-view image corresponding to the position to which the present vehicle performs the automatic driving so as to travel from now. Hence, the processing in step S240 is repeated, and thus the bird's-eye-view image output from the information providing device 202 to the display device 31 is changed, for example, from the bird's-eye-view image shown in FIG. 18 to a bird's-eye-view image shown in FIG. 19. Thereafter, the picture of the third virtual vehicle is moved to the destination in the bird's-eye-view image (see FIGS. 20 and 21 which will be described later).

Since as described above, in the bird's-eye-view image, the third virtual vehicle is moved along the planned travel route up to the destination of the present vehicle in the automatic driving, it is possible to previously notify the occupant in the present vehicle of what type of behavior the present vehicle takes in the automatic driving from now. In this way, it is possible to provide the occupant in the present vehicle to a feeling of security.

As described above, the rendering picture VR1 of the present vehicle and the picture of the third virtual vehicle are included in the bird's-eye-view image, and thus the occupant in the present vehicle can intuitively grasp a relationship between the current position of the present vehicle and the position of the third virtual vehicle. Hence, the occupant in the present vehicle can intuitively grasp what type of behavior the present vehicle takes in the automatic driving from now. In this way, the feeling of security of the occupant in the present vehicle is enhanced.

As described above, the picture of the third virtual vehicle appears in the current position of the present vehicle and is thereafter moved to the position to which the present vehicle performs the automatic driving so as to travel from now, and thus it appears as if the third virtual vehicle was separated from the present vehicle, with the result that the driver can intuitively grasp the information that the travel route of the third virtual vehicle is the planned travel route up to the destination of the present vehicle in the automatic driving.

In step S250 subsequent to step S240, the image generation portion 22 determines whether or not the third virtual vehicle reaches an intermediate position on the planned travel route. In the present embodiment, a position where the direction in which the present vehicle travels is switched from the forward direction to the backward direction in the automatic driving is set to the intermediate position on the planned travel route. The intermediate position on the planned travel route may be, for example, a position where the direction in which the present vehicle travels is switched from the backward direction to the forward direction, a position in which the present vehicle makes a U-turn, a position in which the present vehicle turns left or a position in which the present vehicle turns right.

When the third virtual vehicle does not reach the intermediate position on the planned travel route, the process is returned to step S210. On the other hand, when the third virtual vehicle reaches the intermediate position on the planned travel route, the process is transferred to step S260.

In step S260, the superimposition portion 22d superimposes the picture of a fourth virtual vehicle on the bird's-eye-view image. The picture of the fourth virtual vehicle is superimposed on a position in the bird's-eye-view image corresponding to the intermediate position on the planned travel route. The picture of the fourth virtual vehicle is a residual picture of the third virtual vehicle.

In step S270 subsequent to step S260, the image generation portion 22 determines whether or not the third virtual vehicle reaches the destination.

When the third virtual vehicle does not reach the destination, the process is immediately returned to step S210. On the other hand, when the third virtual picture reaches the destination, the flow operation is completed.

The bird's-eye-view image immediately before processing in step S260 is performed is, for example, as shown in FIG. 20, and the bird's-eye-view image immediately before the completion of the flow operation is, for example, as shown in FIG. 21. The picture A1 of the fourth virtual vehicle in the bird's-eye-view image shown in FIG. 21 has a form different from the picture V2 of the third virtual vehicle. For example, they are preferably made to have different forms such as by whether or not flashing is performed or colors. The picture A1 of the fourth virtual vehicle and the picture V2 of the third virtual vehicle are made to have different forms, and thus it is possible to prevent the occupant in the present vehicle from confusing the picture A1 of the fourth virtual vehicle and the picture V2 of the third virtual vehicle.

As described above, the picture of the fourth virtual vehicle is left in the intermediate position on the planned travel route, and thus the occupant in the present vehicle can clearly grasp which position on the planned travel route is the intermediate position.

The intermediate position is set to the position where the direction in which the present vehicle travels is switched in the automatic driving, and thus the occupant in the present vehicle can clearly grasp the position in which the behavior of the present vehicle is significantly varied in the automatic driving, with the result that the feeling of security is enhanced. Here, the position where the direction in which the present vehicle travels is switched means a position where the rate of variation in the direction in which the present vehicle travels becomes larger than a threshold value. For example, the threshold value is set relatively large, and thus the position where the direction in which the present vehicle travels is switched is only a position where the forward direction in which the present vehicle travels and the backward direction in which the present vehicle travels are switched. On the other hand, the threshold value is set relatively small, and thus the position where the direction in which the present vehicle travels is switched includes not only the position where the forward direction in which the present vehicle travels and the backward direction in which the present vehicle travels are switched but also a position in which a steering angle is significantly varied in parallel parking or the like.

<2-3. Others>

In addition to the second embodiment described above, various variations can be added to various technical features disclosed in the present specification without departing from the split of the technical creation thereof. A plurality of variations described in the present specification may be combined and practiced if possible.

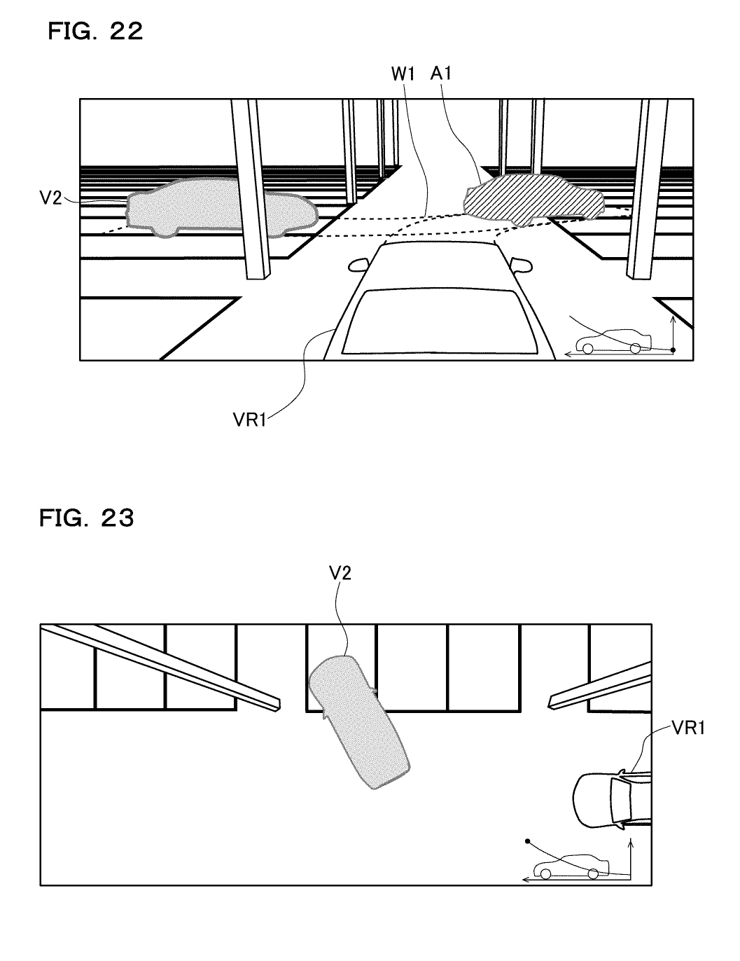

For example, a picture which indicates a movement locus over which the position to which the present vehicle performs the automatic driving so as to travel from now is moved may be generated by the image generation portion 22, and the superimposition portion 22d may superimpose the picture indicating the movement locus on the bird's-eye-view image. In this case, the information providing device 202 generates a bird's-eye-view image shown in FIG. 22 as the bird's-eye-view image immediately before the completion of the flow operation instead of the bird's-eye-view image shown in FIG. 21. On the bird's-eye-view image shown in FIG. 22, the picture W1 indicating the movement locus described above is superimposed. In this way, it is possible to previously and more clearly notify the occupant in the present vehicle of what type of behavior the present vehicle takes in the automatic driving from now.

For example, when the picture of the third virtual vehicle travels in the backward direction, for example, as in the bird's-eye-view image shown in FIG. 23, the bird's-eye-view image generation portion 22a changes the viewpoint position of the virtual viewpoint to a position immediately above the present vehicle, and changes the view direction of the virtual viewpoint to a direction immediately below the present vehicle (substantially in the direction of gravitational force). In this way, it is easy for the occupant in the present vehicle to grasp the movement of the picture of the third virtual vehicle when the picture of the third virtual vehicle travels in the backward direction.

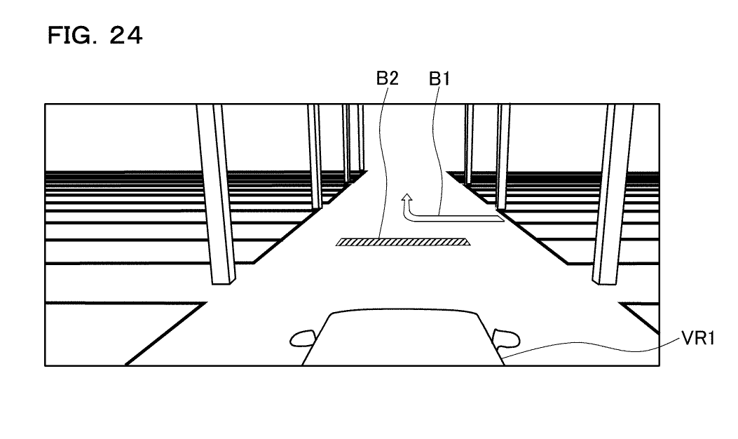

For example, when before the start of the flow operation shown in FIG. 16, the information providing device 202 detects that another vehicle is about to leave the parking lot, the information providing device 202 may generate a bird's-eye-view image as shown in FIG. 24. On the bird's-eye-view image as shown in FIG. 24, a mark B1 which indicates the planned leaving route of the other vehicle and a mark B2 which encourages the present vehicle to be stopped are superimposed. In this way, it is possible to prevent contact between the present vehicle and the other vehicle which is about to leave the parking lot. In the planned travel route up to the destination in the automatic driving, the parking position of the other vehicle which is about to leave the parking lot can be included. In the detection of the information that the other vehicle is about to leave the parking lot, for example, the result of analysis of the shot images by the vehicle-mounted cameras can be used or information which is output from a radar device mounted in the present vehicle or information which can be obtained by communication with a cloud center, vehicle-to-vehicle communication, road-to-vehicle communication or the like can be used.

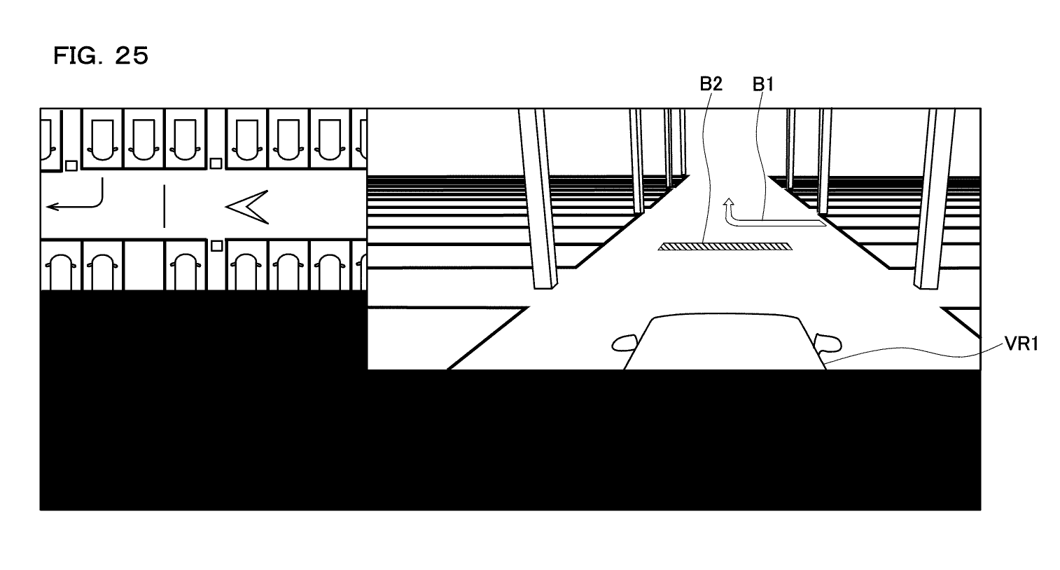

For example, the image generation portion 22 may generate, in addition to the bird's-eye-view image generated by the bird's-eye-view image generation portion 22a, an image which indicates a top view schematically showing the surrounding situation of the present vehicle, and simultaneously display, for example, as shown in FIG. 25, on the display screen of the display device 31, the bird's-eye-view image generated by the bird's-eye-view image generation portion 22a and the image indicating the top view schematically showing the surrounding situation of the present vehicle. In this way, the occupant in the present vehicle can easily grasp the surrounding situation of the present vehicle. The image indicating the top view schematically showing the surrounding situation of the present vehicle can be produced by use of, for example, information which can be obtained by communication with a cloud center, vehicle-to-vehicle communication, road-to-vehicle communication or the like.

For example, when a plurality of candidate routes are present as the planned travel route up to the destination in the automatic driving, the information providing device 202 may display an image indicating the outline of each of the candidate routes on the display device 31 so as to make the occupant in the present vehicle select one of the candidate routes. Alternatively, when a plurality of candidate routes are present as the planned travel route up to the destination in the automatic driving, the information providing device 202 may perform the flow operation shown in FIG. 16 for each of the candidate routes so as to thereafter make the occupant in the present vehicle select one of the candidate routes.

Although in the second embodiment described above, the position in which the picture of the third virtual vehicle appears is the current position of the present vehicle, the position in which the picture of the third virtual vehicle appears may be, from the beginning of the appearance, the position to which the present vehicle performs the automatic driving so as to travel from now.

Although in the second embodiment described above, the shot image is used for the generation of the image (output image) output from the information providing device 202 to the display device 31, the CG (Computer Graphics) showing the vicinity of the present vehicle may be used without use of the shot image so as to generate the output image. When the CG showing the vicinity of the present vehicle is used so as to generate the output image, the information providing device 202 preferably acquires the CG showing the vicinity of the present vehicle from, for example, a navigation device mounted in the present vehicle.

In the output image output from the information providing device 202 to the display device 31, the vehicle speed information of the present vehicle, the range information of a shift lever in the present vehicle and the like may be included.

In the flowchart shown in FIG. 16, steps S250 and S260 may be omitted.

When in the bird's-eye-view image on which the picture of the third virtual vehicle is superimposed, a distance between the third virtual vehicle and the obstacle is equal to or less than a threshold value, in a position in the vicinity of the obstacle, a mark indicating that the obstacle is in the vicinity of the third virtual vehicle may be superimposed. In this way, the occupant in the present vehicle can find that an automatic driving system can properly recognize that the third virtual vehicle and the obstacle are close to each other, with the result that the feeling of security is enhanced.

Although in the second embodiment and the variations of the second embodiment described above, the picture of the third virtual vehicle is superimposed on the region corresponding to the position to which the present vehicle performs the automatic driving so as to travel from now, the picture of the third virtual vehicle may be superimposed on a region corresponding to a position to which the present vehicle travels from now without performing the automatic driving. In this case, as the planned travel route up to the destination, for example, the guide route shown by the navigation device can be used. For example, the intermediate position is provided halfway through an S-shaped curve or a crank road with low visibility, and thus even in a state where the third virtual vehicle is hidden on the output image, the occupant in the present vehicle can drive while relying on the fourth virtual vehicle so as to make the present vehicle follow the third virtual vehicle. In this way, even when the third virtual vehicle is hidden on the output image, it is possible to provide a feeling of security to the occupant in the present vehicle.

Although in the second embodiment and the variations of the second embodiment described above, not only the picture of the third virtual vehicle but also the rendering picture VR1 of the present vehicle is superimposed on the bird's-eye-view image such that the driver can intuitively grasp a relationship between the current position of the present vehicle and the position of the third virtual vehicle, a configuration may be adopted in which the rendering picture VR1 of the present vehicle is not superimposed on the bird's-eye-view image.

Although in the second embodiment and the variations of the second embodiment described above, the output image output by the information providing device is the bird's-eye-view image, the output image output by the information providing device is not limited to the bird's-eye-view image, and for example, the picture of the third virtual vehicle or the like may be superimposed on the shot image of the front camera 11.

What is claimed is:

1. A driving support device comprising:
a generation portion which generates a picture of a first virtual vehicle; and
a superimposition portion which superimposes the picture of the first virtual vehicle on a surrounding image showing a vicinity of a present vehicle,
wherein the picture of the first virtual vehicle is moved, ahead of a current position of the present vehicle, along a guide route up to a destination of the present vehicle in the surrounding image.

2. The driving support device according to claim 1,
wherein the generation portion further generates a picture of a second virtual vehicle indicating the present vehicle, and
the picture of the second virtual vehicle is superimposed on the current position of the present vehicle in the surrounding image.

3. The driving support device according to claim 1,
wherein the picture of the first virtual vehicle appears in the current position of the present vehicle in the surrounding image and is thereafter moved along the guide route up to the destination of the present vehicle.

4. The driving support device according to claim 1,
wherein when the picture of the first virtual vehicle reaches the destination, the picture of the first virtual vehicle is stopped at the destination in the surrounding image.

5. The driving support device according to claim 2,
wherein when the picture of the first virtual vehicle reaches the destination, the picture of the first virtual vehicle is stopped at the destination in the surrounding image, and thereafter when the picture of the second virtual vehicle reaches the destination, the picture of the first virtual vehicle disappears from the surrounding image.

6. The driving support device according to claim 2, further comprising:
a determination portion which determines whether or not the picture of the second virtual vehicle follows the picture of the first virtual vehicle; and
a form change portion which changes a form of the picture of the first virtual vehicle according to a result of the determination by the determination portion.

7. The driving support device according to claim 2,
wherein when a state where the picture of the second virtual vehicle does not follow the picture of the first virtual vehicle is degraded beyond a predetermined level, the picture of the first virtual vehicle disappears from the surrounding image.

8. The driving support device according to claim 1,
wherein when a length of the guide route is equal to a predetermined value, the picture of the first virtual vehicle appears in the surrounding image.

9. A driving support method comprising:
a generation step of generating a picture of a first virtual vehicle; and
a superimposition step of superimposing the picture of the first virtual vehicle on a surrounding image showing a vicinity of a present vehicle,
wherein the picture of the first virtual vehicle is moved, ahead of a current position of the present vehicle, along a guide route up to a destination of the present vehicle in the surrounding image.

10. An information providing device comprising:
a generation portion which generates a picture of a third virtual vehicle; and
a superimposition portion which superimposes the picture of the third virtual vehicle on a surrounding image showing a vicinity of a present vehicle,
wherein the picture of the third virtual vehicle is moved along a planned travel route up to a destination of the present vehicle in the surrounding image and
at least one intermediate position is provided on the planned travel route, and when the picture of the third virtual vehicle passes the intermediate position, a picture of a fourth virtual vehicle is superimposed on a position in the surrounding image corresponding to the intermediate position.

11. The information providing device according to claim 10,
wherein the picture of the third virtual vehicle appears in a current position of the present vehicle in the surrounding image and is thereafter moved along the planned travel route up to the destination.

12. The information providing device according to claim 10,
wherein the planned travel route is a route along which the present vehicle performs automatic driving from now so as to travel up to the destination.

13. The information providing device according to claim 10,
wherein the picture of the fourth virtual vehicle has a form different from the picture of the third virtual vehicle.

14. The information providing device according to claim 10,
wherein the intermediate position is a position on the planned travel route where a direction in which the present vehicle travels is switched.

15. The information providing device according to claim 10,
wherein the generation portion generates a picture of a movement locus over which the picture of the third virtual vehicle is moved, and
the superimposition portion superimposes the picture of the movement locus on the surrounding image.

16. An information providing method comprising:
a generation step of generating a picture of a third virtual vehicle; and
a superimposition step of superimposing the picture of the third virtual vehicle on a surrounding image showing a vicinity of a present vehicle,
wherein the picture of the third virtual vehicle is moved along a planned travel route up to a destination of the present vehicle in the surrounding image and
at least one intermediate position is provided on the planned travel route, and when the picture of the third virtual vehicle passes the intermediate position, a picture of a fourth virtual vehicle is superimposed on a position in the surrounding image corresponding to the intermediate position.
